(19) United States
(12) Patent Application Publication
(10) Pub. No.: US 2017/0336778 A1
(43) Pub. Date: Nov. 23, 2017

(54) ON-DEMAND TOOL KITS

(71) Applicant: SIKORSKY AIRCRAFT CORPORATION, STRATFORD, CT (US)

(72) Inventor: Ryan Patry, Hamden, CT (US)

(21) Appl. No.: 15/522,146

(22) PCT Filed: Nov. 10, 2015
(86) PCT No.: PCT/US15/59923

§ 371 Date: Apr. 26, 2017

Related U.S. Application Data
(60) Provisional application No. 62/077,424, filed on Nov. 10, 2014.

(51) Int. Cl. G05B 19/4099; B33Y 50/02

(52) U.S. Cl. CPC G05B 19/4099; B33Y 50/02; G05B 2219/49007

(57) ABSTRACT

An on-demand system for manufacturing service tools is provided. The system includes a digital manual including instructions for service/repair configured to be accessible by a computing device and a library containing one or more additive manufacturing files configured to be accessible by the computing device. An additive manufacturing printer is provided in communication with the computing device and configured to receive instructions therefrom based on the one or more additive manufacturing files. The system also includes a recycling device configured to recycle materials of items created by the additive manufacturing printer. The digital manual includes one or more links to the one or more additive manufacturing files of the library.

### BACKGROUND OF THE INVENTION

The embodiments herein generally relate to tool creation and generation thereof and more specifically to on-demand tool kits.

Various specialized and/or custom tools are required to perform service, maintenance, and/or repair on consumer, commercial, and industrial equipment, such as aircraft, oil rigs, vehicles, etc., hereinafter “equipment.” The equipment can be located at remote locations around the globe. Because of the size, nature, or other factors of the equipment, services may be required to be performed at the site of the equipment, rather than the equipment being brought to a specialized service facility. For example, if a service needs to be performed on an aircraft, it may be necessary to perform the service at the airport where the aircraft is located. This may be due to the fact that it may be unsafe for the aircraft to fly to a specialized location for the servicing. Thus, services may need to be carried out around the world, and at many distinct, and potentially remote, locations, rather than at specialized service facilities.

Further, as noted, the equipment may be of a construction and contain parts that require unique tools or other equipment, hereinafter “service tool(s),” to perform the servicing. Thus, the service tools may be specific to the particular equipment, and may not be uniform and/or readily available at the location of the equipment. For example, the service tool may need to be custom made for a specific service application, and may service only one or a few specialized tasks.

In view of this, a service technician must either bring specialized service tools to a site or the site must already have the specialized service tools available. This can be costly, either in terms of travel or in terms of having unique service tools at each and every location where a specialized piece of equipment is located or may be located (i.e., at every airport an aircraft may land). Either way, this results in high costs of transporting specialized service tools (or it may not be feasible to transport the service tools) and/or the need to store custom service tools and/or custom service tool kits all over the world and the need to maintain the appropriate service tools on-site. This results in large storage requirements, and also increases the costs of maintaining equipment, particularly with a mobile fleet of equipment, such as aircraft.

### BRIEF DESCRIPTION OF THE INVENTION

According to one embodiment, an on-demand system for manufacturing service tools is provided. The system includes a digital manual including instructions for service/repair configured to be accessible by a computing device and a library containing one or more additive manufacturing files configured to be accessible by the computing device. An additive manufacturing printer is provided in communication with the computing device and configured to receive instructions therefrom based on the one or more additive manufacturing files. The system also includes a recycling device configured to recycle materials of items created by the additive manufacturing printer. The digital manual includes one or more links to the one or more additive manufacturing files of the library.

In addition to one or more of the features described above or below, or as an alternative, further embodiments could include that the one or more additive manufacturing files define the shape and processing requirements for service tools. In some embodiments, the additive manufacturing files are configured to be modified by a user to create a modified file. In some of the embodiments, the modified file is saved into at least one of the library and a sub-library.

Additionally, in some embodiments, the system further includes a computing device configured to display the manual, access the library, and communicate with the additive manufacturing printer. In some embodiments, the computing device comprises one of a personal computer, a tablet, and a smart phone.

In some of the above embodiments, the instructions for service/repair are instructions for servicing or repairing an aircraft or parts thereof.

According to another embodiment, a process for manufacturing service tools on demand is provided. The process includes presenting on a display screen a manual including one or more instructions and one or more links linked to one or more additive manufacturing files for custom service tools, accepting an input from a user when a user selects at least one of the one or more links for the custom service tools, and transmitting instructions, based on the selected one or more links, to an additive manufacturing printer to instruct the printer to manufacture one or more custom service tools.

In addition to one or more of the features described above or below, or as an alternative, further embodiments could include printing one or more custom service tool from raw materials based on the instructions received at the additive manufacturing printer. In some of the embodiments, the process further includes recycling the printed one or more custom service tools to convert the one or more printed custom service tools back to the raw materials.

In some embodiments, prior to transmitting the instructions to the additive manufacturing printer, opening a program to display a digital representation of the one or more custom service tools. Further, in some embodiments, the process includes accepting user inputs that modify the one or more additive manufacturing files of the one or more custom service tools. In some of these embodiments, the one or more modified additive manufacturing files are saved into a library. Further, in combination with any of these embodiments, the additive manufacturing files may be stored in a digital library.

Technical effects of embodiments of the invention include providing an on-demand library of instructions for service and repair and associated tools and tool kits for service and repair that are linked within the instructions to allow for on-site generation of customized tools. Further, technical effects of embodiments of the invention include providing a whole life cycle for raw materials of additive printing of service tools on-site, thus providing a complete on-site manufacturing process that is tailored to specific needs of industries that require customized and/or specialized tools for service and repair tasks.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic of a service tool manufacturing system in accordance with an exemplary embodiment of the invention;

FIG. 2 is an exemplary illustration of a view of a manual of instructions in accordance with an embodiment of the invention; and

FIG. 3 is a flow chart detailing the process of generating service tools in accordance with an embodiment of the invention.

### DETAILED DESCRIPTION OF THE INVENTION

Various exemplary embodiments of the invention provide a digital service manual connected and/or embedded with a custom service tool database in order to enable on-demand construction of service tools in-situ. The digital service manual provides the instructions for performing service and/or repair operations on equipment. In accordance with some embodiments, the digital service manual may include a list(s) of service tools that are required to perform a specific service, maintenance, repair, and/or similar related task(s). The manual enables a user to create and/or manufacture a service tool directly on site with the equipment to be serviced or repaired.

In order to create the service tools, on-site and on-demand, an additive manufacturing printer is provided at the site of the repair or service. Additive manufacturing, as used herein, refers to any of the various processes for printing a three-dimensional object. For example, an additive process may include layering a material into successive layers under computer control. These objects can be of almost any shape or geometry, and are based on 3D model(s) or other electronic data source(s), including CAD models, solid works models, etc., and can be represented and/or stored in digital files. The files and representations that can be displayed from the files will hereinafter be referred to as “additive manufacturing file(s),” and includes all file types that can be used to manufacture 3D printed objects. The objects printed and/or manufactured in accordance with embodiments of the invention can be formed from various raw materials that provide, when formed, structural integrity to the level and demands of tools. For example, aluminum, polymers, carbon-fiber reinforced materials, etc., may be employed in forming the service tools of the invention. Further, the on-site manufactured tools may be made with the intent to add non-manufactured components and/or parts (e.g., prefabricated components and/or parts), such as durable inserts, strengthening inserts, grips, bearing surfaces, etc.

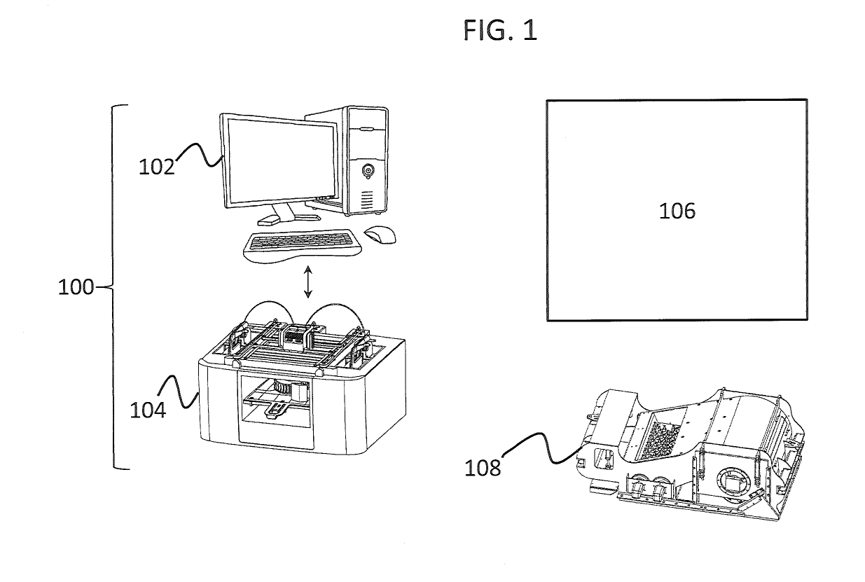

Turning now to FIG. 1, an exemplary schematic of a service tool manufacturing system in accordance with an embodiment of the invention is shown. A service tool manufacturing system 100 includes a computing device 102 and an additive printer 104 connected thereto. The system 100 is located proximal to a piece of equipment 106 that is to be serviced. Equipment, as used herein, may be any consumer, commercial, and/or industrial equipment, including, but not limited to aircraft, oil rigs, vehicles, etc., that may requirement servicing, maintenance, and/or repairs thereon. The manufacturing system 100 further includes a recycling device 108 configured to recycle items and objects created with the additive printer 104.

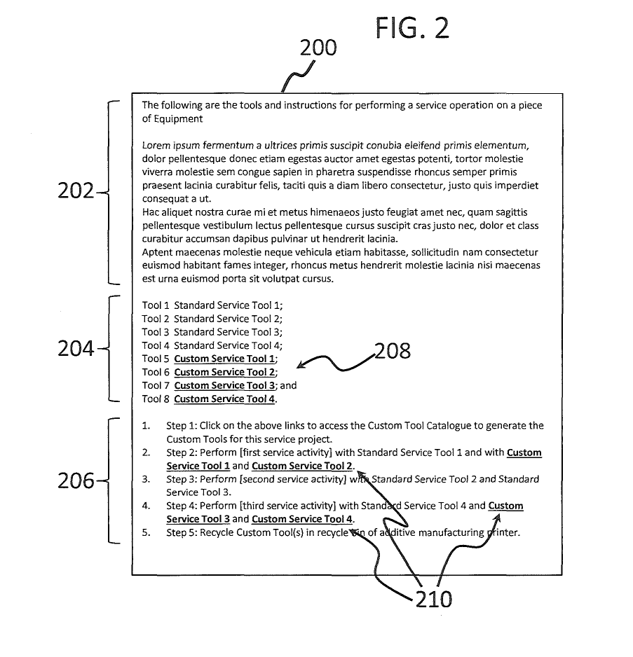

The computing device 102 may be any standard computer with memory, processing unit(s), inputs/outputs, etc., such as desktop computers and laptops. Further, in some embodiments, the computing device 102 may be a portable computing device, such as a tablet, smart phone, etc. The computing device 102 is configured to run programs, access networks, and to send and receive commands. For example, the computing device 102 can receive inputs from a user, which may be by keyboard/mouse input and/or by touch screen or other types of input. Further, the computing device 102 can provide output to the user (on a display screen, etc.) and/or transmit output to other devices, such as the additive printer 104. For example, the computing device 102, in accordance with embodiments of the invention, is configured to display an interactive manual or other instruction program (see FIG. 2) that a user (i.e., a technician) may interact with.

The connection between the computing device 102 and the additive printer 104 may be by wire or wireless communication. Accordingly, the connection may be a Wi-Fi, Bluetooth®, or other similar wireless communication protocol and can be a direct communication link between the computing device 102 and the additive printer 104, or the communication link may be provided through a server, network, or other intermediary communication protocol.

The interactive instructions or manual, as displayed on the computing device 102, may include any number of service and repair instructions regarding any number of types of equipment and provide detailed instruction(s) on a particular service or repair task. Within the digitally displayed interactive manual are links to the service tools that are required for a particular selected service/repair. The links, when selected, may open a window, program, or other display screen that presents a digital file (additive manufacturing file) and associated representation of the service tool that was linked. The computing device 102 can then be used to modify, edit, and/or interact with the additive manufacturing file of the service tool, as discussed below. The additive manufacturing file of the service tool can then be sent to the attached additive printer 104. The additive printer 104 will then manufacture or create on-site, and in relative proximity to the equipment 106 that is to be serviced/repaired, the selected service tool.

A technician or user can thus create a service tool on-site, and on-demand. The service/repair tasks can be completed using the manufactured service tools. After the task is completed, the service tool that was manufactured on-site can be recycled in the recycling device 108 and converted back into raw materials for the generation and manufacture of another service tool.

Turning now to FIG. 2, an exemplary page or view of a digital service manual 200 in accordance with embodiments of the invention is shown. The digital manual 200 may be similar to an encyclopedia. For example, the digital manual may include an index of all equipment that is discussed within the manual, and further may include an index or sub-index providing a listing of all of the maintenance, services, and types of repair that may be required for each piece of equipment. Thus, a user can search for a piece of equipment, and further search for the exact task to be completed.

Manual 200 includes instructions to perform a selected service/repair operation for a piece of equipment and is an exemplary display of a view on the computing device 102 of FIG. 1. The instructions, as shown, include an introduction section 202, which may include preliminary text, warnings, safety advisements, etc. Following introduction section 202 is a listing 204 of the tools that are required for the selected service/repair. Tool listing 204 includes both standard service tools and custom service tools that will be required to perform the service/repair operation.

As shown in the example of FIG. 2, eight service tools will be required for the service/repair. Service tools 1-4 are each listed as a “Standard Service Tool,” and indicate that the service tool is one that is standardized and easily and/or readily available and/or can be used for multiple functions, i.e., not specialized. As shown, the standard service tools include Standard Service Tool 1, Standard Service Tool 2, Standard Service Tool 3, and Standard Service Tool 4. Examples of standard service tools include hammers, screwdrivers, wrenches, etc. The standard service tools can be used on a variety of equipment and perform a variety of tasks without the requirement to be customized to the particular piece of equipment or to the particular service and/or repair job to be completed. Thus, standard service tools may be stored on-site and/or brought to a site by a technician without difficulty. Because standard service tools have multiple and various uses, providing these on-site does not present an unreasonable burden on storage space and/or cost. This is because standard service tools may be low cost tools and/or may be readily available for purchase.

In contrast, service tools 5-8, on page 200, each are listed as a “Custom Service Tool,” and indicate a custom service tool that is required for the particular service and/or repair to be completed. As shown, the custom service tools include Custom Service Tool 1, Custom Service Tool 2, Custom Service Tool 3, and Custom Service Tool 4. The text of the custom service tools in the Tool List 204 are in bold and underline font, and are illustrated to be hyperlinks 208. Below the tool listing 204 are the step-by-step instructions 206 for performing the service and/or repair. As shown, the instructions 206 also include hyperlinks 210, which are provided for each of the custom tools used in each of the appropriate steps. Thus, the links to specific tools can be provided directly within an instruction step. This is advantageous, for example, when the instructions 206 span multiple pages.

In some embodiments, rather than or in addition to links to each individual custom service tool, a link to a kit or plurality of tools may be provided. Thus, a technician or user can select a kit link related to the particular service or repair to access all of the custom service tools for that job. Further, in some embodiments, the kit link may allow for the additive manufacturing printer to print all of the custom service tools required for the specified job or task. Accordingly, with reference to FIG. 2, in an alternative embodiment, hyperlinks 208 may be a single hyperlink entitled “Custom Service Tool Kit” or some similar indicator. Further, in some embodiments the Tool List 204 may begin with a kit link, and then be followed by links to individual custom service tools.

The hyperlinks 208 and 210 are configured to link to a database or library of tools, and specifically, to the exact tool that is referenced on the page 200. The database includes the additive manufacturing files, i.e., files defining the shapes and process parameters and includes digital models of the custom service tools that are needed for servicing and repairing equipment. For example, a service company may service a number of different types of equipment for a number of different industries. Each piece of equipment may require one or more unique tools in order for the equipment to be serviced and/or repaired. Thus, the library can be created that includes the additive manufacturing files for manufacturing the custom service tools for all industries and/or equipment to be serviced by the company. The library, in some embodiments, may be stored on the local computing device that the user is using. In some alternative embodiments, the library may be stored on servers and/or at a remote location(s) that is not at the site. Thus, the computing device used by the technician may connect to the internet or some other network to access the interactive instruction manual and the library. In some embodiments, the interactive instruction manual is stored locally on the computing device and the links direct to a remote database, while in other embodiments, the manual and the links may all be accessed through a connection such as the internet and not stored locally.

As noted, a technician or user can select the particular equipment and task to be carried out. The technician can then select a link for a custom service tool that will be required for the job at hand and have the service tool manufactured by the additive manufacturing printer that is located on-site. The technician may then have the opportunity to further customize the custom service tool, using the computing device. Once complete, the computing device will send a completed or finalized additive manufacturing file to the additive printer. The additive printer will then use the additive manufacturing file to physically create the custom service tool to the specifications and requirements input by the technician. The technician can then use the custom-made service tool(s), made on-site, along with the standard service tool(s), to complete the service and/or repair.

After the technician completes the service and/or repair, the custom service tool(s) will no longer be necessary. Accordingly, the custom-made service tool(s) can be recycled for the raw materials. For example, used custom service tool(s) may be ground up and reverted to the raw materials, such that other custom service tool(s) can be made from the same raw materials, i.e., used tools can be recycled into raw materials to feed the printer. This can be done on a per-job or even per-tool basis, depending on the available raw materials and the needs of the user.

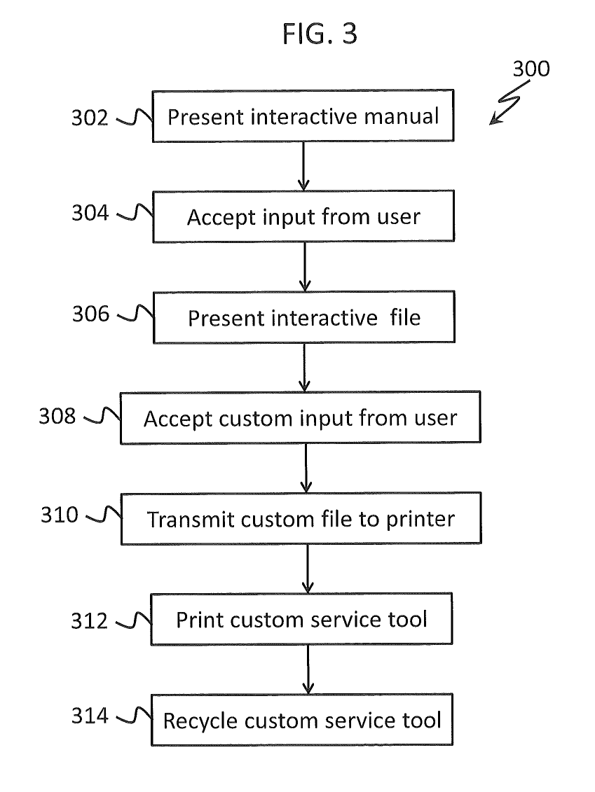

Turning now to FIG. 3, a flow chart of a process 300 in accordance with the invention is shown. At step 302 a computing device, such as a computer, tablet, or other electronic device having a display screen, presents interactive instructions or an interactive manual including instructions (e.g., step-by-step instructions) on how to perform a service or repair task for a specific piece of equipment. The interactive instructions include links to custom service tools needed for the service/repair. At step 304, the user inputs or selects a custom service tool from the instructions and the computing device accepts the input from the user. At step 306 the computer will then present the user with an additive manufacturing file or a modifiable digital version of the custom service tool. The digital version may open or start at a default model that has been predesigned and/or preconfigured for a specific task, i.e., a default setting for a custom service tool. For example, the computing device will open or change programs (i.e., open a file in a different program than the instructions) to display the additive manufacturing file of the custom service tool default model along with input commands that can be used to modify the additive manufacturing default file, to the requirements of the user.

At step 308, a user may input any desired changes to the default model and the computer will accept the inputs to create a completed file representing the custom service tool that is to be made by the additive manufacturing printer. The completed file will then be sent to the additive manufacturing printer for processing at step 310. At step 312, the additive manufacturing printer manufactures, forms, prints, and/or creates a physical custom service tool according to the specifications, dimensions, and requirements as presented in the completed additive manufacturing file. The user can then use the custom service tool to complete the service and/or repair on the equipment.

After the custom service tool has been used for its purpose, the custom service tool may be recycled at step 314. As such, the raw materials that were used to make the custom service tool can be reused to form another custom service tool.

Advantageously, embodiments of the invention provide a custom process and system for manufacturing customized service tools, on-demand, and on-site, for the purpose of services and repairs. Further, advantageously, embodiments of the invention provide an integrated instruction manual and library to produce custom service tools. Moreover, advantageously, various embodiments of the invention allow for in-situ and on-site customization and/or modification of the custom service tool additive manufacturing files to create on-demand custom service tool that are made especially for a particular task.

In an alternative embodiment, a user or technician can modify the custom service tool(s) to be further customized to the needs of the job and/or to the specifics of the user. For example, in one embodiment, a user can select a service tool from the manual/instructions, and will then be prompted with custom options for the specific service tool. In some embodiments, the technical features of the tool may be locked or unmodifiable. For example, the diameter or dimension of a specific working head or working feature of the service tool may be locked or unmodifiable. However, the remainder of the tool may be customizable to the user's desires and/or needs. For example, the user may be able to select or modify a default service tool configuration to be better configured for a left-handed operator, or non-critical features may be changed such as length of handles, etc. Further, in some embodiments, sub-versions of custom service tools and/or sub-libraries may be created that are specific to particular users and/or based on in-the-field experience. The sub-libraries may be accessible by all users or may be saved specifically for a particular user. Thus, advantageously, various embodiments of the invention provide a modifiable and updateable library of additive manufacturing files for custom service tools.

In another alternative embodiment, similar to the user-specific embodiment, described above, users may be able to fully modify and/or customize the dimensions, configurations, etc., of the custom service tools in the library. For example, if a technician arrives on-site for a scheduled maintenance and it is discovered that the equipment is damaged and the custom service tool needs to be modified to fit or work properly to perform the task, the technician can modify the additive manufacturing file such that the custom service tool is made to the needs for the service/repair. These additional modifications can be saved into user or technician specific profiles, or saved in the larger database as a sub-version of the default version in the database or in a sub-library.

While the invention has been described in detail in connection with only a limited number of embodiments, it should be readily understood that the invention is not limited to such disclosed embodiments. Rather, the invention can be modified to incorporate any number of variations, alterations, substitutions, combination, sub-combination, or equivalent arrangements not heretofore described, but which are commensurate with the spirit and scope of the invention. Additionally, while various embodiments of the invention have been described, it is to be understood that aspects of the invention may include only some of the described embodiments.

For example, as described herein, the invention has been directed to tools for service and repair of equipment. However, the invention is not limited to merely service tools, and may be directed to parts of equipment, custom components, or accessories, etc. For example, the library and additive manufacturing process described herein may be used for items such as earplugs, covers, eyewear, etc., that may be custom made on-site for the user of the system. Moreover, although described as using a computer and an additive manufacturing printer, various embodiments may be modified to use other types of control/display devices that are known or will become known, and other types of printers and/or manufacturing devices that are known or will become known, without departing from the scope of the invention. Further, although described with respect to single tools, it is to be understood that tool kits may be created as described above.

Further, not all steps of the process are required. For example, when a user selects a link to a service tool, an instruction may be sent directly to the additive printer for manufacturing, omitting the step of allowing for customization. In this embodiment, advantageously, the default files may not be able to be modified, which may prevent users from creating service tools that could potentially damage the equipment to be worked on. Further, in embodiments such as this, the link may directly send the instructions to the additive printer for very quick and easy access for making custom service tools on demand.

Accordingly, the invention is not to be seen as limited by the foregoing description, but is only limited by the scope of the appended claims.

1. An on-demand system for manufacturing service tools comprising:
a digital manual including instructions for service/repair configured to be accessible by a computing device;
a library containing one or more additive manufacturing files configured to be accessible by the computing device;
an additive manufacturing printer in communication with the computing device and configured to receive instructions therefrom based on the one or more additive manufacturing files; and
a recycling device configured to recycle materials of items created by the additive manufacturing printer,
wherein the digital manual includes one or more links to the one or more additive manufacturing files of the library.

2. The on-demand system of claim 1, wherein the one or more additive manufacturing files define the shape and processing requirements for service tools.

3. The on-demand system of claim 1, wherein the additive manufacturing files are configured to be modified by a user to create a modified file.

4. The on-demand system of claim 3, wherein the modified file is saved into at least one of the library and a sub-library.

5. The on-demand system of claim 1, further comprising a computing device configured to display the manual, access the library, and communicate with the additive manufacturing printer.

6. The on-demand system of claim 5, wherein the computing device comprises one of a personal computer, a tablet, and a smart phone.

7. The on-demand system of claim 1, wherein the instructions for service/repair are instructions for servicing or repairing an aircraft or parts thereof.

8. A process for manufacturing service tools on demand comprising:
presenting on a display screen a manual including one or more instructions and one or more links linked to one or more additive manufacturing files for custom service tools;
accepting an input from a user when a user selects at least one of the one or more links for the custom service tools; and
transmitting instructions, based on the selected one or more links, to an additive manufacturing printer to instruct the printer to manufacture one or more custom service tools.

9. The process of claim 8, further comprising printing one or more custom service tool from raw materials based on the instructions received at the additive manufacturing printer.

10. The process of claim 9, further comprising recycling the printed one or more custom service tools to convert the one or more printed custom service tools back to the raw materials.

11. The process of claim 8, further comprising, prior to transmitting the instructions to the additive manufacturing printer, opening a program to display a digital representation of the one or more custom service tools.

12. The process of claim 11, further comprising accepting user inputs that modify the one or more additive manufacturing files of the one or more custom service tools.

13. The process of 12, wherein the one or more modified additive manufacturing files are saved into a library.

14. The process of claim 8, wherein the additive manufacturing files are stored in a digital library.
